(19) United States
(12) Patent Application Publication
(10) Pub. No.: US 2026/0063840 A1
(43) Pub. Date: Mar. 5, 2026

(54) SILICON PHOTONIC SEMICONDUCTOR DEVICE AND MANUFACTURING METHOD THEREOF

(71) Applicant: Taiwan Semiconductor Manufacturing Company, Ltd., Hsinchu (TW)

(72) Inventors: Sheng Kai YEH, Hsinchu (TW); Shu-Wei CHANG, Hsinchu (TW); Chi-Yuan SHIH, Hsinchu (TW); Shih-Fen HUANG, Hsinchu (TW)

(73) Assignee: Taiwan Semiconductor Manufacturing Company, Ltd., Hsinchu (TW)

(21) Appl. No.: 18/817,585

(22) Filed: Aug. 28, 2024

(51) Int. Cl. G02B 6/12; G02B 6/136; G02B 6/293

(52) U.S. Cl. CPC G02B 6/12007; G02B 6/136; G02B 6/29338; G02B 6/29395

(57) ABSTRACT

A silicon photonic semiconductor device includes a modulator and a heater. The modulator includes a bus waveguide and a silicon ring. The silicon ring is optically coupled to the bus waveguide, and the heater is configured to heat the silicon ring. The heater includes a first silicon thermal resistance region and a second silicon thermal resistance region. The first silicon thermal resistance region is disposed on an outer ring portion of the silicon ring, and the outer ring portion has a first conductivity type doping. The second silicon thermal resistance region is disposed on an inner ring portion of the silicon ring and the inner ring portion has a second conductivity type dopant. The first conductivity type dopant and the second conductivity type dopant have different electrical properties.

### BACKGROUND

Recent information technology advances, such as Big Data, cloud computation, cloud storage, and Internet of Things, have been driving exponential growth of data communication in high performance computers, data centers, and long-haul telecommunication. Silicon photonics is poised to provide a fast on-chip and off-chip optical link for data communication that has low cost and high energy efficiency.

Micro ring modulator (MRM) is one of the most important components in silicon photonics platform, which is a promising candidate for high-speed data transmission as compared with Mach-Zehnder modulator (MZM) due to its compact footprint. However, MRM is very sensitive to process variation and typically requires integrated micro heater integration for wavelength control after processes.

In terms of thermal efficiency performance index, doped silicon heater typically has better thermal efficiency than metal heater using Tungsten or TiN, and has lower concern for electron migration reliability issue. However, when doped silicon heater is combined with MRM, the electrical routing is more difficult as compared with metal heater due to the routing for P/N junction of MRM.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of an optical communication system.

FIG. 2 is a schematic top view of a silicon photonic semiconductor device according to an embodiment of the present disclosure.

FIG. 3 is a schematic diagram of a silicon photonic semiconductor device along the A-A′ cross-sectional line according to an embodiment of the present disclosure.

FIG. 4 is a schematic diagram showing a first voltage difference being applied to the outer ring portion of the silicon ring according to an embodiment of the present disclosure.

FIG. 5 is a schematic diagram showing a second voltage difference being applied to the inner ring portion of the silicon ring according to an embodiment of the present disclosure.

FIG. 6 is a flow chart of a method for manufacturing a silicon photonic semiconductor device according to an embodiment of the present disclosure.

FIG. 7A is a schematic diagram of a silicon ring along the B-B′ section line according to an embodiment of the present disclosure.

FIG. 7B is a schematic diagram of a silicon ring along the C-C′ section line according to an embodiment of the present disclosure.

FIG. 8 is a schematic top view of a silicon photonic semiconductor device according to another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus may be otherwise oriented (rotated 90 degrees or at other orientations) and the spatially relative descriptors used herein may likewise be interpreted accordingly.

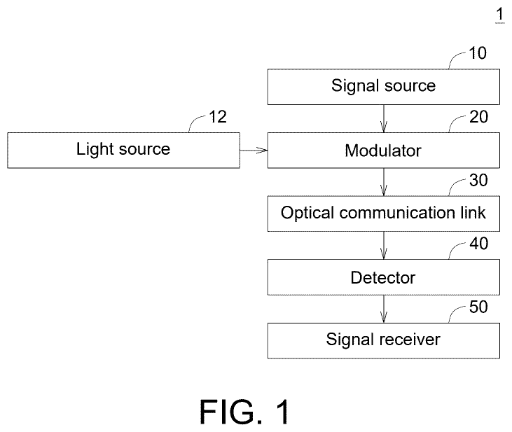

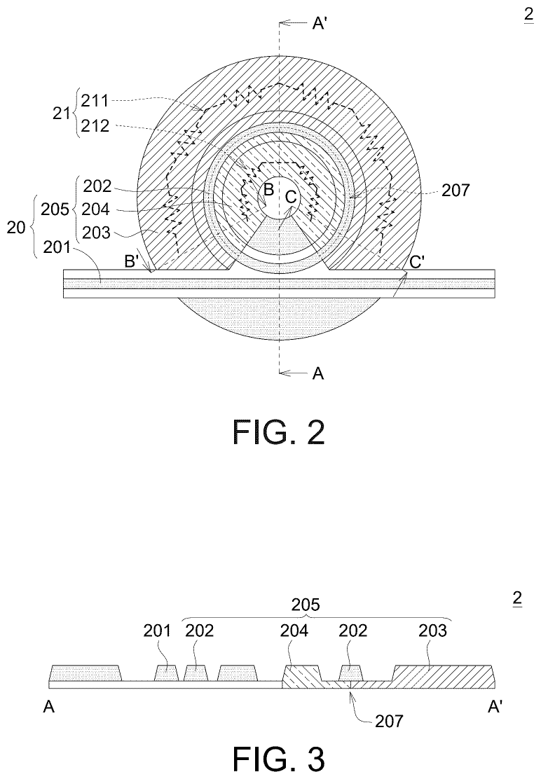

Referring to FIG. 1 and FIG. 2, FIG. 1 is a block diagram of an optical communication system 1. FIG. 2 is a schematic top view of a silicon photonic semiconductor device 2 according to an embodiment of the present disclosure. The silicon photonic semiconductor device 2 can be used in the optical communication system 1. The optical communication system 1 may include a light source 12, a signal source 10, a modulator 20 for modulating/transmitting optical signals from the light source, an optical communication link 30, a detector 40 and a signal receiver 50. The light source 12 is used to generate an optical signal with a predetermined wavelength, and the optical signal is sent to the modulator 20. The silicon photonic semiconductor device 2 is, for example, a semiconductor chip, and the signal source 10 and the modulator 20 (including a heater 21) can be formed in the semiconductor chip for modulating optical signals. In addition, the detector 40 and the signal receiver 50 may be formed in another semiconductor chip for demodulating/decoding the modulated optical signal. The following embodiments describe the modulator 20 for optical modulation, but the principles disclosed herein may also be applied to optical demodulation.

In one embodiment, the modulator 20 uses the electrical signal from the signal source 10 to modulate the optical signal. The signal source 10 may include a circuit for generating an electrical signal (e.g., a radio frequency (RF) signal) that carries digital information, and the electrical signal is used to modulate the optical signal. As an exemplary embodiment, the signal source 10 may include, for example, an error correction coding, modulation, filtering, up-sampling, analog-to-digital conversion (ADC) and a RF processing block. The optical signal may be modulated by the modulator 20 through, for example, amplitude modulation (AM), phase modulation (PM), polarization modulation, or similar methods. The modulated optical signal is transmitted through an optical communication link 30 (e.g., optical fiber network) and converted into an electrical signal by the detector 40 (e.g., an optical detector) located at the end of the receiver. The output of detector 40 is sent to signal receiver 50 which uses the electrical signal from the detector 40 to recover the transmitted digital information. As an example, the signal receiver 50 may include functional blocks such as demodulation, decoding, error correction, etc. In addition, the signal receiver 50 can also provide received measurement information or signal quality indicators to the modulator 20. The measurement information may be bit error rate (BER) measurement, signal-to-noise ratio (SNR) measurement or measurement of the eye-opening in the eye-diagram of the demodulated signal at the signal receiver 50. The modulator 20 can adjust its parameters (e.g., resonant wavelength or heating power) to optimize or improve the quality of the received signal at the signal receiver 50.

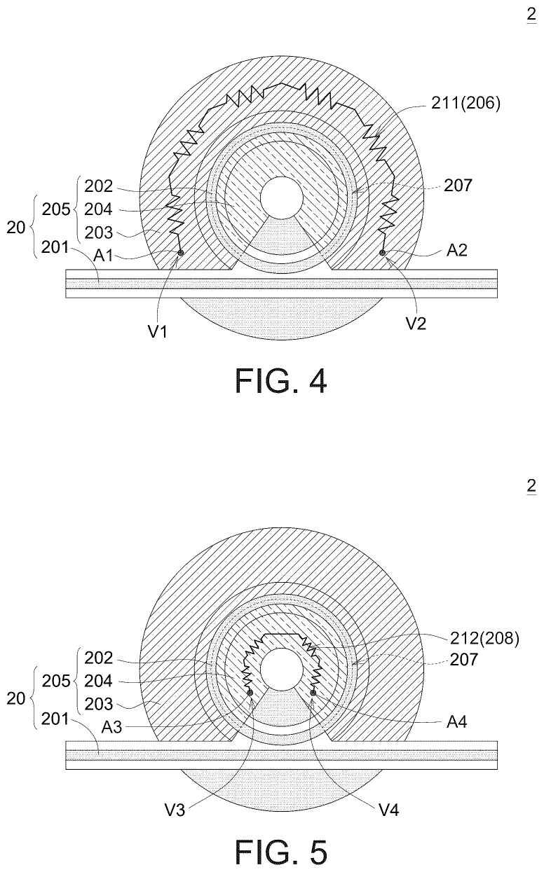

Referring to FIG. 2, the silicon photonic semiconductor device 2 includes a modulator 20 and a heater 21. The modulator 20 includes a bus waveguide 201 and a silicon ring 205. The silicon ring 205 is optically coupled to the bus waveguide 201. The heater 21 is configured to heat the silicon ring 205, and a heating element of the heater 21 (e.g., resistors 206, 208, see FIGS. 4 and 5) is integrated into the modulator 20. The heater 21 may include other components, such as a temperature sensor for monitoring the temperature of the silicon ring 205 or a voltage control circuit and/or current control circuit for controlling the voltage across the heating element and/or the current flowing through the heating element. In some embodiments, the voltage control circuit and/or the current control circuit of the heater 21 is used to regulate the heating power of the heating component, and are controlled by the heater control unit (e.g., a microcontroller or a digital logic) of the modulator 20, thereby maintaining the target temperature of the silicon ring 205 during the operation of the silicon photonic semiconductor device 2. For example, a closed-loop control can be performed, and the heater control unit monitors the measured temperature of the silicon ring 205 and issues different control commands to the heater 21, thereby the voltage control circuit and/or current control circuit of the heater 21 can adjust the heating power of the heating element accordingly to maintain the target temperature of the silicon ring 205.

As shown in FIG. 2, the silicon ring 205 includes an outer ring portion 203 and an inner ring portion 204. The outer ring portion 203 is located outside the silicon ring 205, and the inner ring portion 204 is located inside the silicon ring 205. The outer ring portion 203 and the inner ring portion 204 are connected to form an annular waveguide 202.

Referring to FIG. 4, the heater 21 includes a first silicon thermal resistance region 211 and a second silicon thermal resistance region 212. In FIG. 2, the zigzag dotted line represents the situation when no voltage is applied to the first and second silicon thermal resistance regions 211 and 212. In FIGS. 4 and 5, the zigzag solid line represents the situation when a voltage difference is applied to the first and second silicon thermal resistance regions 211 and 212 to form resistors 206 and 208, respectively. The first silicon thermal resistance region 211 is disposed on an outer ring portion 203 of the silicon ring 205. When two opposite ends of the first silicon thermal resistance region 211 receive a voltage difference, the outer ring portion 203 of the silicon ring 205 forms a conduction current flowing through the first silicon thermal resistance region 211 to generate a first heat source. The first heat source can increase the temperature of the outer ring portion 203 of the silicon ring 205. That is to say, the semiconductor material (such as silicon or other elements) in the first silicon thermal resistance region 211 can be used as a heating element (such as resistors 206) of the heater 21. The two ends of the first silicon thermal resistance region 211 are respectively a first voltage input terminal A1 and a second voltage input terminal A2. The voltage difference between the first voltage input terminal A1 and the second voltage input terminal A2 is set to control the amount of currents in the outer ring portion 203 of the silicon ring 205. Therefore, the conduction currents in the outer ring portion 203 of the silicon ring 205 can change with the magnitude of the applied voltage difference.

In addition, referring to FIG. 5, the second silicon thermal resistance region 212 is provided in an inner ring portion 204 of the silicon ring 205. When two opposite ends of the second silicon thermal resistance region 212 receive a voltage difference, the inner ring portion 204 of the silicon ring 205 forms a conduction current flowing through the second silicon thermal resistance region 212 to generate a second heat source. The second heat source can increase the temperature of the inner ring portion 204 of the silicon ring 205. That is to say, the semiconductor material (such as silicon or other elements) in the second silicon thermal resistance region 212 can be used as a heating element (such as resistors 208) of the heater 21. The two opposite ends of the second silicon thermal resistance region 212 are respectively a third voltage input terminal A3 and a fourth voltage input terminal A4. The voltage difference between the third voltage input terminal A3 and the fourth voltage input terminal A4 is set to control the amount of currents in the inner ring portion 204 of the silicon ring 205. Therefore, the conduction currents in the silicon ring 205 can change with the magnitude of the applied voltage difference.

Referring to FIG. 4, in some embodiments, the first voltage input terminal A1 can receive the first voltage V1 from the signal source 10, and the second voltage input terminal A2 can receive the second voltage V2 from the signal source 10. The first voltage V1 is, for example, 10V or other voltage values, and the second voltage V2 is, for example, 0V or other voltage values. In an embodiment, the first voltage V1 may be greater than the second voltage V2. In another embodiment, the first voltage V1 may be smaller than the second voltage V2.

Referring to FIG. 5, in some embodiments, the third voltage input terminal A3 can receive the third voltage V3 from the signal source 10, and the fourth voltage input terminal A4 can receive the fourth voltage V4 from the signal source 10. The third voltage V3 is, for example, 8V or other voltage values, and the fourth voltage V4 is, for example, −2V or other voltage values. In an embodiment, the third voltage V3 may be greater than the fourth voltage V4. In another embodiment, the third voltage V3 may be smaller than the fourth voltage V4.

In some embodiments, in order to maintain substantially the same bias voltage between the inner ring portion 204 and the outer ring portion 203 of the silicon ring 205 in the radial direction of the silicon ring 205, the voltage between the first voltage input terminal A1 and the third voltage input terminals A3 is maintained at a first bias voltage, and the voltage between the second voltage input terminal A2 and the fourth voltage input terminal A4 is maintained at a second bias voltage. The first bias voltage and the second bias voltage are substantially the same. For example, the difference between the first voltage V1 and the third voltage V3 is about 2V, and the difference between the second voltage V2 and the fourth voltage V4 is about 2V. Therefore, the inner ring portion 204 and the outer ring portion 203 of the silicon ring 205 maintain a reverse bias voltage of about −2V in the radial direction of the silicon ring 205.

Referring to FIG. 3, FIG. 3 is a schematic diagram of the silicon photonic semiconductor device 2 along the A-A′ cross-sectional line according to an embodiment of the present disclosure. The A-A′ cross-sectional line is directed to the radial direction of the silicon ring 205. According to the A-A′ cross-sectional view, the inner ring portion 204 and the outer ring portion 203 of the silicon ring 205 are connected at the annular waveguide 202 to form a P/N junction 207. The outer ring portion 203 has a first conductivity type dopant, and the inner ring portion 204 has a second conductivity type dopant. The first conductive type dopant is, for example, an N-type semiconductor material, and the second conductive type dopant is, for example, a P-type semiconductor material. The holes in the P-type semiconductor material and the electrons in the N-type semiconductor material combine at the P/N junction 207, thereby causing a lack of carriers in the region near the P/N junction 207 and forming a depletion region or space charge region. The force generated by the ions in the depletion region to prevent electrons and holes from passing through the P/N junction 207 is called the “potential barrier”. Generally speaking, the potential barrier of the P/N junction 207 of germanium is about 0.2-0.3V, and the potential barrier of the P/N junction 207 of silicon is about 0.6-0.7V.

In some embodiments, when the first voltage input terminal A1 of the outer ring portion 203 (doped N-type semiconductor) is applied with a positive voltage, the third voltage input terminal A3 of the inner ring portion 204 (doped P-type semiconductor) is applied with a negative voltage, that is, the first voltage V1 is greater than the third voltage V3, the depletion region of the P/N junction 207 will become larger due to the reverse bias voltage, so that it is more difficult for electrons and holes to combine, and no current could flow through the P/N junction 207. In addition, when a positive voltage is applied to the second voltage input terminal A2 of the outer ring portion 203 (doped N-type semiconductor), and a negative voltage is applied to the fourth voltage input terminal A4 of the inner ring portion 204 (doped P-type semiconductor), that is, the second voltage V2 is greater than the fourth voltage V4, and the depletion region of the P/N junction 207 will become larger due to the reverse bias, so that it is more difficult for electrons and holes to combine, and no current could flow through the P/N junction 207.

Therefore, through the reverse bias, the operating voltage of the silicon ring 205 of the modulator 20 can be maintained at about −1V to about −2V.

Generally speaking, Mach-Zehnder Modulator (MZM), Arrayed Waveguide Grating (AWG) and other optical components with larger sizes are used in the silicon photonic semiconductor device. However, the use of MZM and AWG results in larger chip sizes and higher manufacturing costs. The larger size of MZM may be attributed to the relatively weak electro-optic (EO) effect in silicon. To compensate for the relatively weak EO effect in silicon, MZMs tend to have large sizes. In this embodiment, since MZM has larger size and higher cost, Micro ring modulator (MRM) is a promising candidate for high-speed data transmission as compared with Mach-Zehnder modulator (MZM) due to its compact footprint.

In one embodiment, the bus waveguide 201 may be formed of a semiconductor material such as silicon, and the first silicon thermal resistance region 211 and the second silicon thermal resistance region 212 of the heater 21 are made of a suitable semiconductor material (for example, silicon) and doped with dopants of opposite types (e.g., N-type or P-type) to form two annular regions (i.e., the outer ring portion 203 and the inner ring portion 204). For example, the first silicon thermal resistance region 211 may be an N-type doped region (e.g., a silicon region doped with N-type dopants), and the second silicon thermal resistance region 212 may be a P-type doped region (e.g., a silicon region doped with P-type dopants) and vice versa. The P/N junction 207 is formed at the annular waveguide 202 between the first silicon thermal resistance region 211 (outer ring portion 203) and the second silicon thermal resistance region 212 (inner ring portion 204). The P/N junction 207 forms a depletion region, as described above.

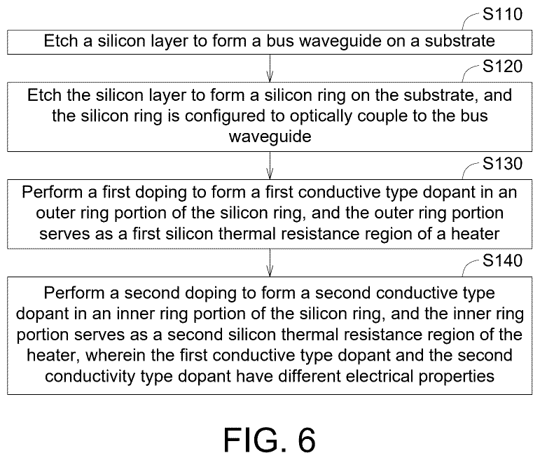

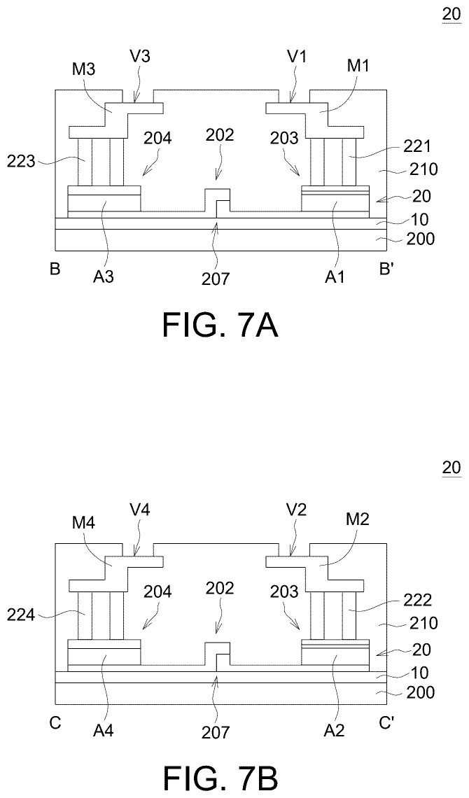

Referring to FIGS. 6 and 7, FIG. 6 is a flow chart of a method for manufacturing a silicon photonic semiconductor device 2 according to an embodiment of the present disclosure. First, in step S110, a silicon layer is etched to form a bus waveguide 201 on a substrate 200. In step S120, the silicon layer is etched to form a silicon ring 205 on the substrate 200, and the silicon ring 205 is optically coupled to the bus waveguide 201. In step S130, a first doping is performed to form a first conductive type dopant on an outer ring portion 203 of the silicon ring 205. The outer ring portion 203 serves as a first silicon thermal resistance region 211 of a heater 21 (see FIG. 2). The first conductive type dopant is, for example, an N-type semiconductor material. In step S140, a second doping is performed to form a second conductive type dopant in an inner ring portion 204 of the silicon ring 205, and the inner ring portion 204 serves as a second silicon thermal resistance region 212 of the heater 21 (see FIG. 2), wherein the first conductivity type dopant and the second conductivity type dopant have different electrical properties. The second conductive type dopant is, for example, a P-type semiconductor material.

In one embodiment, the substrate 200 may be a semiconductor substrate such as doped or undoped silicon or a semiconductor-on-insulator (SOI) substrate. The semiconductor substrate may include: other semiconductor materials, such as germanium; compound semiconductors, including silicon carbide, gallium arsenide, gallium phosphide, gallium nitride, indium phosphide, indium arsenide, and/or indium antimonide; alloy semiconductors, including SiGe, GaAsP, AlInAs, AlGaAs, GaInAs, GaInP and/or GaInAsP or combinations thereof. Other substrates may also be used, such as multi-layered substrates or trapezoidal substrates. In FIGS. 7A and 7B, the modulator 20 can be formed on an bottom oxide layer 10 deposited on the substrate 200. The bottom oxide layer 10 acts as a better seed layer for the growth of uniform silicon layer on the substrate 200.

A plurality of dielectric layers 210 are formed on the substrate 200. The dielectric layer 210 may be made of, for example, silicon oxide, silicon nitride, a low-k dielectric layer (such as a carbon-doped oxide), an extremely low-k dielectric layer made of one or more suitable dielectric materials (such as silicon dioxide doped with porous carbon), combinations thereof, or the like. Although any suitable process may be utilized, the dielectric layer 210 may be formed by a process such as chemical vapor deposition (CVD).

The silicon ring 205 may be formed by: forming a silicon layer (e.g., Si) on the substrate 200; doping the silicon layer with an N-type or P-type dopant; and patterning the silicon layer to form the designed shape of the corresponding area. The first silicon thermal resistance region 211 and the second silicon thermal resistance region 210 are formed at the same level. The first silicon thermal resistance region 211 and the second silicon thermal resistance region 212 have L-shaped cross sections. For example, the first silicon thermal resistance region 211 and the second silicon thermal resistance region 212 are thicker in the P/N junction 207 and thinner in other regions. In other words, the upper surface of the P/N junction 207 is higher than the upper surface of the portion of the first silicon thermal resistance region 211 away from the P/N junction 207, and the upper surface of the P/N junction 207 is higher than the upper surface of the portion of the second silicon thermal resistance region 212 away from the P/N junction 207. As discussed above, the outer ring portion 203 (i.e., the first silicon thermal resistance region 211) and the inner ring portion 204 (i.e., the second silicon thermal resistance region 212) are connected in the radial direction of the silicon ring 205 and form a P/N junction 207 at the annular waveguide 202.

Since the outer ring portion 203 containing the N-type semiconductor is used as a first silicon thermal resistance region 211 of the heater 21, and the inner ring portion 204 containing the P-type semiconductor is used as a second silicon thermal resistance region 212 of the heater 21 to heat the modulator 20, there is no need to install an additional metal heating element and its routing on the silicon ring 205, thereby the winding and its occupying footprint of the heater 21 is simplified.

The modulator 20 (including the heating element) disclosed herein can be implemented in the silicon photonic semiconductor device 2 with a smaller footprint.

FIG. 7A and FIG. 7B respectively illustrate a schematic diagram of the silicon ring 20 along the B-B′ section line and the C-C′ section line according to an embodiment of the present disclosure. In one embodiment, the first voltage input terminal A1 is coupled to a conductive via 221 vertically connected between the first metal contact M1 and the outer ring portion 203, and the second voltage input terminal A2 is coupled to another conductive via 222 vertically connected to between the second metal contact M2 and the outer ring portion 203, the first and second metal contacts M1 and M2 are configured to receive the first voltage V1 and the second voltage V2 for heating the first the silicon thermal resistance region 211 to a target temperature. In addition, the third voltage input terminal A3 is coupled to a conductive via 223 vertically connected between the third metal contact M3 and the inner ring portion 204, and the fourth voltage input terminal A4 is coupled to another conductive via 224 vertically connected between the fourth metal contact M4 and the inner ring portion 204, the third and fourth metal contacts M3 and M4 are configured to receive a third voltage V3 and a fourth voltage V4 for heating the second silicon thermal resistance region. 212 to a target temperature. The P/N junction 207 is formed at the annular waveguide 202 between the first silicon thermal resistance region 211 (outer ring portion 203) and the second silicon thermal resistance region 212 (inner ring portion 204). The P/N junction 207 forms a depletion region, as described above. When the first voltage V1 is greater than the third voltage V3, the depletion region of the P/N junction 207 will become larger due to the reverse bias voltage, and it is more difficult for electrons and holes to combine, so that no current flows through the P/N junction. 207. In addition, when the second voltage V2 is greater than the fourth voltage V4, the depletion region of the P/N junction 207 will become larger due to the reverse bias, and it is more difficult for electrons and holes to combine, so that no current flows through the P/N junction 207.

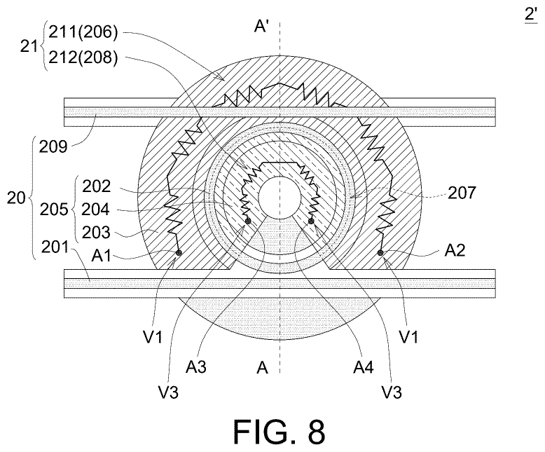

Referring to FIG. 8, FIG. 8 is a schematic top view of a silicon photonic semiconductor device 2′ according to another embodiment of the present disclosure. The silicon photonic semiconductor device 2′ is similar to the silicon photonic semiconductor device 2 shown in FIG. 2, and the relevant description is as follows: the optical signal can be modulated by the modulator 20 through, for example, amplitude modulation (AM), phase modulation, PM), polarization modulation or similar methods. The modulated optical signal is transmitted through an optical communication link 30 (e.g., optical fiber network) and converted into an electrical signal by a detector 40 (e.g., optical detector) located at the end of the receiver. The output of detector 40 is sent to signal receiver 50 which uses the electrical signal from detector 40 to recover the transmitted digital information. The modulator 20 can adjust its parameters (e.g., resonant wavelength or heating power) to optimize or improve the quality of the received signal at signal receiver 50.

Referring to FIG. 8, the modulator 20 includes a first bus waveguide 201, a second bus waveguide 209 and a silicon ring 205. The silicon ring 205 is optically coupled to the first bus waveguide 201 and the second bus waveguide 209. The optical signal may be optically coupled to the second bus waveguide 209 and output at the drop port of the second bus waveguide 209 after being modulated by the modulator 20. It should be noted that the silicon photonic semiconductor device 2′ can function not only as an optical modulator 20 but also as an optical multiplexer. As shown in FIG. 8, the optical signal originally transmitted in the first bus waveguide 201 is combined into the second bus waveguide 209 after being modulated. Therefore, the silicon photonic semiconductor device 2′ can be used to divide optical signals.

The heater 21 includes a first silicon thermal resistance region 211 and a second silicon thermal resistance region 212. In FIG. 8, the zigzag solid line represents the situation when a pair of voltage differences is applied to the first and second silicon thermal resistance regions 211 and 212 to form resistors 206 and 208, respectively. The first silicon thermal resistance region 211 is disposed on an outer ring portion 203 of the silicon ring 205. When two opposite ends of the first silicon thermal resistance region 211 receive a voltage difference, the outer ring portion 203 of the silicon ring 205 forms a conduction current flowing through the first silicon thermal resistance region 211 to generate a first heat source. The first heat source can increase the temperature of the outer ring portion 203 of the silicon ring 205. That is to say, the semiconductor material (such as silicon or other elements) in the first silicon thermal resistance region 211 can be used as a heating element of the heater 21, and two opposite ends of the first silicon thermal resistance region 211 are respectively a first voltage input terminal A1 and a second voltage input terminal A2. The voltage difference between the first voltage input terminal A1 and the second voltage input terminal A2 is set to control the amount of currents in the outer ring portion 203 of the silicon ring 205. Therefore, the conduction currents in the outer ring portion 203 of the silicon ring 205 can change with the magnitude of the voltage difference.

In addition, the second silicon thermal resistance region 212 is disposed on an inner ring portion 204 of the silicon ring 205. When the opposite ends of the second silicon thermal resistance region 212 receive a voltage difference, the inner ring portion 204 of the silicon ring 205 forms a conduction current flowing through the second silicon thermal resistance region 212 to generate a second heat source. The second heat source can increase the temperature of the inner ring portion 204 of the silicon ring 205. That is to say, the semiconductor material (such as silicon or other elements) in the second silicon thermal resistance region 212 can be used as a heating element of the heater 21, and the two opposite ends of the second silicon thermal resistance region 212 are respectively a third voltage input terminal A3 and a fourth voltage input terminal A4. The voltage difference between the third voltage input terminal A3 and the fourth voltage input terminal A4 is set to control the amount of currents in the inner ring portion 204 of the silicon ring 205. Therefore, the conduction currents in the inner ring portion 204 of the ring 205 can change with the magnitude of the voltage difference.

In some embodiments, in order to maintain substantially the same bias voltage between the inner ring portion 204 and the outer ring portion 203 of the silicon ring 205 in the radial direction of the silicon ring 205, the voltage between the first voltage input terminal A1 and the third voltage input terminals A3 is maintained at a first bias voltage, and the voltage between the second voltage input terminal A2 and the fourth voltage input terminal A4 is maintained at a second bias voltage. The first bias voltage and the second bias voltage are substantially the same. For example, the difference between the first voltage V1 and the third voltage V3 is about 2V, and the difference between the second voltage V2 and the fourth voltage V4 is about 2V. Therefore, the inner ring portion 204 and the outer ring portion 203 of the silicon ring 205 maintain a reverse bias voltage of about −2V in the radial direction of the silicon ring 205.

The outer ring portion 203 has a first conductivity type dopant, and the inner ring portion 204 has a second conductivity type dopant. The first conductive type dopant is, for example, an N-type semiconductor material, and the second conductive type dopant is, for example, a P-type semiconductor material. When a positive voltage is applied to the first voltage input terminal A1 of the outer ring portion 203 (including an N-type semiconductor), and a negative voltage is applied to the third voltage input terminal A3 of the inner ring portion 204 (including a P-type semiconductor), that is, the first voltage V1 is greater than the third voltage V3, and no current flows through the P/N junction 207. In addition, when a positive voltage is applied to the second voltage input terminal A2 of the outer ring portion 203 (including an N-type semiconductor), and a negative voltage is applied to the fourth voltage input terminal A4 of the inner ring portion 204 (including a P-type semiconductor), that is, the second voltage V2 is greater than the fourth voltage V4, and no current flows through the P/N junction 207.

Since the outer ring portion 203 containing the N-type semiconductor is used as a first silicon thermal resistance region 211 of the heater 21, and the inner ring portion 204 containing the P-type semiconductor is used as a second silicon thermal resistance region 212 of the heater 21 to heat the modulator 20. Therefore, there is no need to install an additional metal heating element and its routing on the silicon ring 205, thereby the winding and its occupying footprint of the heater 21 is simplified.

The modulator 20 (including the heating element) disclosed herein can be implemented in the silicon photonic semiconductor device 2′ with a smaller footprint.

In some embodiments, the modulator 20 is configured to selectively couple optical signals into or out of the bus waveguide 201. The modulator 20 is located close to but not touching the bus waveguide 201. The size of a gap between the modulator 20 and the bus waveguide 201 determines the coupling efficiency between the modulator 20 and the bus waveguide 201. In some embodiments, a gap between the modulator 20 and the bus waveguide 201 ranges from about 0.01 microns (μm) to about 10 μm. In some embodiments, the modulator 20 has a width in the range from about 0.01 μm to about 10 μm, and the modulator 20 has a radius in the range from about 1 μm to about 30 μm.

In addition, the first silicon thermal resistor region 211 has a dopant concentration ranging from about 1e17 dopants/cm³ to about 1e19 dopants/cm³. The second silicon thermal resistor region 212 has a dopant concentration ranging from about 1e17 dopants/cm³ to about 1e19 dopants/cm³. The dopant concentration of the first silicon thermal resistor region 211 may be the same as or different from the dopant concentration of the second silicon thermal resistor region 212.

The present disclosure is directed to a silicon photonic semiconductor device and a manufacturing method thereof. The modulator adopts a doped-silicon heater design, it leverages the original pattern and location of silicon ring in micro ring modulator with novel routing arrangement which could simultaneously heat up the inner ring portion of the doped-silicon heater and the outer ring portion of the doped-silicon heater for thermal efficiency enhancement. While at the same time, the electrical routing concept does not affect the original MRM P/N bias in operation. Therefore, the silicon ring in micro ring modulator is made directly without additional complex routing or space arrangement for doped-Si heater.

According to some embodiments of the present disclosure, a silicon photonic semiconductor device including a modulator and a heater is provided. The modulator includes a bus waveguide and a silicon ring. The silicon ring is optically coupled to the bus waveguide, and the heater is configured to heat the silicon ring. The heater includes a first silicon thermal resistance region and a second silicon thermal resistance region. The first silicon thermal resistance region is disposed on an outer ring portion of the silicon ring, and the outer ring portion has a first conductivity type doping. The second silicon thermal resistance region is disposed on an inner ring portion of the silicon ring and the inner ring portion has a second conductivity type dopant. The first conductivity type dopant and the second conductivity type dopant have different electrical properties.

According to some embodiments of the present disclosure, a silicon photonic semiconductor device including a modulator and a heater is provided. The modulator includes a first bus waveguide, a second bus waveguide and a silicon ring. The silicon ring is optically coupled to the first bus waveguide and the second bus waveguide, and the heater is configured to heat the silicon ring. The heater includes a first silicon thermal resistance region and a second silicon thermal resistance region. The first silicon thermal resistance region is disposed on an outer ring portion of the silicon ring, and the outer ring portion has a first conductivity type doping. The second silicon thermal resistance region is disposed on an inner ring portion of the silicon ring and the inner ring portion has a second conductivity type dopant. The first conductivity type dopant and the second conductivity type dopant have different electrical properties.

According to some embodiments of the present disclosure, a method for manufacturing a silicon photonic semiconductor device is provided. A silicon layer is etched to form a bus waveguide on a substrate. The silicon layer is etched to form a silicon ring on the substrate, and the silicon ring is configured to optically couple to the bus waveguide. A first doping is performed to form a first conductivity type dopant on an outer ring portion of the silicon ring, the outer ring portion serving as a first silicon thermal resistance region of a heater. A second doping is performed to form a second conductivity type dopant in an inner ring portion of the silicon ring, and the inner ring portion serves as a second silicon thermal resistance region of the heater, wherein the first conductivity type dopant and the second conductivity type dopant have different electrical properties.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A silicon photonic semiconductor device, comprising:
a modulator comprising a bus waveguide and a silicon ring optically coupled to the bus waveguide; and
a heater configured to heat the silicon ring, wherein the heater comprises a first silicon thermal resistance region and a second silicon thermal resistance region, the first silicon thermal resistance region is disposed on an outer ring portion of the silicon ring and the outer ring portion has a first conductive type dopant, the second silicon thermal resistance region is disposed on an inner ring portion of the silicon ring and the inner ring portion has a second conductive type dopant, and the first conductive type dopant and the second conductivity type dopant have different electrical properties.

2. The silicon photonic semiconductor device of claim 1, wherein the first silicon thermal resistance region and the second silicon thermal resistance region are integrated in the silicon ring.

3. The silicon photonic semiconductor device of claim 1, wherein the outer ring portion and the inner ring portion are connected to form an annular waveguide.

4. The silicon photonic semiconductor device of claim 3, wherein the inner ring portion and the outer ring portion of the silicon ring are connected in a radial direction of the silicon ring and form a P/N junction at the annular waveguide, the P/N junction maintains a bias voltage.

5. The silicon photonic semiconductor device of claim 4, wherein when two opposite ends of the first silicon thermal resistance region receive a first voltage difference, the outer ring portion of the silicon ring forms a conduction current flowing through the first silicon thermal resistance region to generate a first heat source.

6. The silicon photonic semiconductor device of claim 5, wherein when two opposite ends of the second silicon thermal resistance region receive a second voltage difference, the inner ring portion of the silicon ring forms a conduction current flowing through the second silicon thermal resistance region to generate a second heat source.

7. The silicon photonic semiconductor device of claim 6, wherein the two opposite ends of the first silicon thermal resistance region receive a first voltage and a second voltage respectively, the first voltage is greater than the second voltage, and the two opposite ends of the second silicon thermal resistance region receive a third voltage and a fourth voltage respectively, and the third voltage is greater than the fourth voltage.

8. The silicon photonic semiconductor device of claim 7, wherein the first voltage difference and the second voltage difference are equal, a first bias voltage is formed between the first voltage and the third voltage, and a second bias voltage is formed between the second voltage and the fourth voltage, and the first bias voltage is equal to the second bias voltage.

9. A silicon photonic semiconductor device, comprising:
a modulator comprising a first bus waveguide, a second bus waveguide, and a silicon ring optically coupled to the first bus waveguide and the second bus waveguide; and
a heater configured to heat the silicon ring, wherein the heater comprises a first silicon thermal resistance region and a second silicon thermal resistance region, the first silicon thermal resistance region is disposed on an outer ring portion of the silicon ring and the outer ring portion has a first conductive type dopant, the second silicon thermal resistance region is disposed on an inner ring portion of the silicon ring and the inner ring portion has a second conductive type dopant, the first conductive type dopant and the second conductivity type dopant have different electrical properties.

10. The silicon photonic semiconductor device of claim 9, wherein the inner ring portion and the outer ring portion of the silicon ring are connected in a radial direction of the silicon ring to form a P/N junction, and the P/N junction maintains a bias voltage.

11. The silicon photonic semiconductor device of claim 9, wherein two opposite ends of the first silicon thermal resistance region receive a first voltage and a second voltage respectively, and two opposite ends of the second silicon thermal resistance region receive a third voltage and a fourth voltage respectively, wherein a first bias voltage is formed between the first voltage and the third voltage, a second bias voltage is formed between the second voltage and the fourth voltage, and the first bias voltage is equal to the second bias voltage.

12. The silicon photonic semiconductor device of claim 11, wherein a first voltage difference is maintained between the first voltage and the second voltage, and a second voltage difference is maintained between the third voltage and the fourth voltage, the first voltage difference is equal to the second voltage difference.

13. A method for manufacturing a silicon photonic semiconductor device, comprising:
etching a silicon layer to form a bus waveguide on a substrate;
etching the silicon layer to form a silicon ring on the substrate, the silicon ring being configured to optically couple to the bus waveguide;
performing a first doping to form a first conductivity type dopant on an outer ring portion of the silicon ring, the outer ring portion serving as a first silicon thermal resistance region of a heater; and
performing a second doping to form a second conductivity type dopant in an inner ring portion of the silicon ring, and the inner ring portion serves as a second silicon thermal resistance region of the heater, wherein the first conductivity type dopant and the second conductivity type dopant have different electrical properties.

14. The method of claim 13, wherein the first silicon thermal resistance region and the second silicon thermal resistance region are integrated in the silicon ring.

15. The method of claim 13, wherein the outer ring portion and the inner ring portion are connected to form an annular waveguide.

16. The method of claim 15, wherein the inner ring portion and the outer ring portion of the silicon ring are connected in a radial direction of the silicon ring and form a P/N junction at the annular waveguide, the P/N junction maintains a bias voltage.

17. The method of claim 16, wherein when two opposite ends of the first silicon thermal resistance region receive a first voltage difference, the outer ring portion of the silicon ring forms a conduction current flowing through the first silicon thermal resistance region to generate a first heat source.

18. The method of claim 17, wherein when two opposite ends of the second silicon thermal resistance region receive a second voltage difference, the inner ring portion of the silicon ring forms a conduction current flowing through the second silicon thermal resistance region to generate a second heat source.

19. The method of claim 18, wherein the two opposite ends of the first silicon thermal resistance region receive a first voltage and a second voltage respectively, the first voltage is greater than the second voltage, and the two opposite ends of the second silicon thermal resistance region receive a third voltage and a fourth voltage respectively, and the third voltage is greater than the fourth voltage.

20. The method of claim 19, wherein the first voltage difference is equal to the second voltage difference, a first bias voltage is formed between the first voltage and the third voltage, and a second bias voltage is formed between the second voltage and the fourth voltage, and the first bias voltage is equal to the second bias voltage.
